(19) United States
(12) Patent Application Publication
(10) Pub. No.: US 2013/0103496 A1
(43) Pub. Date: Apr. 25, 2013

(54) GENERATION OF USER PROFILES BASED ON FUTURE LOCATIONS

(71) Applicants: Bharathi Shekar, Bangalore (IN); Piyush Kumar Srivastava, Bangalore (IN); Ashootosh Chand, Bangalore (IN)

(72) Inventors: Bharathi Shekar, Bangalore (IN); Piyush Kumar Srivastava, Bangalore (IN); Ashootosh Chand, Bangalore (IN)

(73) Assignee: Yahoo! Inc., Sunnyvale, CA (US)

(21) Appl. No.: 13/276,328

(22) Filed: Oct. 19, 2011

(51) Int. Cl. G06Q 30/02; G06F 15/18

(52) U.S. Cl. 705/14.53; 706/12

(57) ABSTRACT

A computer-implemented method for generating user profiles based on future locations of a user includes receiving one or more future locations along with time duration of a user at each of the one or more future locations. The computer-implemented method also includes identifying a plurality of attributes associated with the one or more future locations. Further, the computer-implemented method includes inferring future interests of the user. Moreover, the computer-implemented method includes dynamically generating user profiles in accordance with the time duration of the user at each of the one or more future locations.

### FIELD OF THE INVENTION

This invention relates generally, to targeted advertising, and more specifically, to generate user profiles based on future locations of a user.

### BACKGROUND

Internet advertising is generally contextual. Advertisements viewed by a user are generally related to content displayed on a web page. For example, a travel website can include the advertisements related to resorts. Further, the advertisements can be customized to specific needs of the user. Various targeting techniques are used to understand past needs of the user by tracking behavior of the user during browsing. An advancement of the targeting techniques allows analyzing a present behavior of the user.

A profile of the user is generated based on the tracked behavior of the user. Advertisements are then displayed to the user based on the profile. However, at times the behavior of the user in the past may not be consistent over a period of time. For example, the user may be interested to view advertisements related to sports last week but at present, the user may be interested to view advertisements related to electronic gadgets. As a result, the advertisements displayed to the user are not to the user's interests. Consequently, it is not possible to predict the needs of the user in future. Specifically, when the user wishes to travel across various geographical locations, the profile does not match with the tracked behavior of the user in the past.

In light of the foregoing discussion, there is a need for an efficient method and system for generating user profiles based on future locations of the user.

### SUMMARY

The above-mentioned needs are met by a method, system, and computer program product for generating user profiles based on future locations of a user.

An example of a computer-implemented method includes receiving one or more future locations along with time duration of a user at each of the one or more future locations. The computer-implemented method also includes identifying a plurality of attributes associated with the one or more future locations. Further, the computer-implemented method includes inferring future interests of the user. Furthermore, the computer-implemented method includes generating user profiles in accordance with the time duration of the user at each of the one or more future locations, wherein the generating is performed dynamically and statically.

An example of a computer program product includes receiving one or more future locations along with time duration of a user at each of the one or more future locations. The computer program product also includes identifying a plurality of attributes associated with the one or more future locations. Further, the computer program product includes inferring future interests of the user. Furthermore, the computer program product includes generating user profiles in accordance with the time duration of the user at each of the one or more future locations, wherein the generating is performed dynamically and statically.

An example of a system for generating user profiles based on future locations of a user includes a receiving unit to receive one or more future locations having time duration of a user at each of the one or more future locations, and to receive a current location of the user. The system also includes a computing device to define an upper bounding level of the one or more future locations, and to identify a plurality of attributes associated with the one or more future locations. Further, the system includes a timer unit in communication with the computing device, to track duration of the user at the one or more future locations. Furthermore, the system includes an ad selection server in communication with the computing device.

Advantageously, a profile of the user is updated dynamically and statically in correspondence with the future locations.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a flow diagram illustrating a method for generating user profiles based on future locations of a user, in accordance with one embodiment;

FIG. 2 is a schematic diagram illustrating a dynamic and time bound feature of generating user profiles, in accordance with one embodiment;

FIG. 3 is a block diagram illustrating a system for generating user profiles based on future locations of a user, in accordance with one embodiment;

FIG. 4 is a block diagram illustrating a mobile computing device, in accordance with one embodiment; and

FIG. 5 is an exemplary representation of dynamically generating user profiles, in accordance with one embodiment.

### DETAILED DESCRIPTION

A method, system, and computer program product for generating user profiles based on future locations of a user is disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

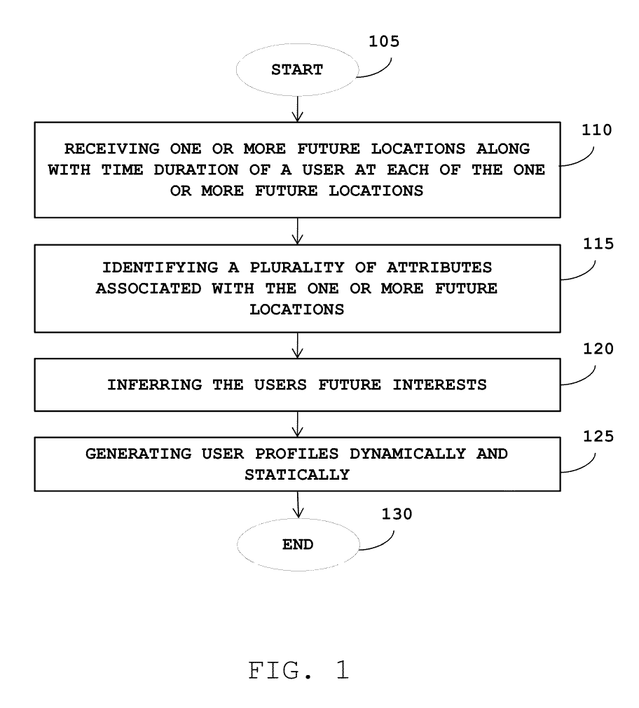

FIG. 1 is a flow diagram illustrating a method for generating user profiles based on future locations of a user, in accordance with one embodiment.

At step 110, one or more future locations along with the time duration of the user at each of the future locations are received from the user. In some embodiments, travel dates of the user to the one or more future locations are received. The time duration of the user at each of the one or more future locations is then computed from the received travel dates. A current location of the user is also received from the user.

The current location and the future locations can be defined as geographical mapping information, for example names of cities, states, regions and countries.

The current location and the future locations are user-inputted locations. The user-inputted locations can be obtained when the user browses a website and opts to share the location details. In one embodiment, the user-inputted locations can also be obtained from any application running on a user device. The user device can also be a location aware device. The location aware device is capable of delivering information about the physical location of the user device to another application. Examples of location aware device include but are not limited to a GPS mobile phone, General Packet Radio Services (GPRS) mobile phone and geo-location tagging on a laptop.

In another embodiment, the current location of the user can be tracked from a plurality of information. Examples of the information include, but are not limited to, Global Positioning System (GPS)-based information, and Internet Protocol (IP) address and triangulation information.

In some embodiments, the current location of the user can be also tracked by Wireless Fidelity (Wi-Fi) networks by comparing nearby Media Access Control (MAC) addresses. The MAC address is a unique hardware number assigned to a computer connected in a local area network (LAN) or any other network. In other embodiments, the current location can also be tracked by Hypertext Markup Language (HTML) files viewed by the user while browsing the web. Further, in other embodiments, the current location of the user can also be tracked by using bluetooth or Radio-frequency identification (RFID) based technologies.

In one example, the user might want to travel from the current location to the future locations. For example, the user is currently located in India. In future, the user might want to visit Sri Lanka and stay for a period of seven days. On the seventh day, the user leaves Sri Lanka and visits Singapore for a period of ten days. At the end of the tenth day, the user returns back to India. In another example, the user is currently located in Chicago on tenth of May, 2011. The user then declares future locations as New York on fifteenth of May, 2011 and San Francisco on twenty fifth of May, 2011. The user then returns to Chicago on twenty ninth of May, 2011. The time duration of the user staying at the future locations is then computed from the declared dates. For example, the user stays in New York for ten days and in San Francisco for four days.

In some embodiments, the time duration of the user at the future locations can be computed using Yahoo! Maps, Google maps or Yahoo! Calendar application.

The time duration of the user at the future locations is used to analyze the interests of the user.

At step 115, a plurality of attributes associated with the future locations is identified.

The attributes include, but are not limited to, nature of the future locations, relationship between the future locations, relationship between the user and people with whom the user travels, and period of travel of the user. The nature of the future locations indicates purpose of travel of the user. For example, the user may travel to Delhi for a business conference. The relationship between the future locations indicates a common feature associated between the future locations. For example, Sri Lanka, Singapore, Malaysia and Maldives are tourist spots. Further, the relationship between the user and the people with whom the user travels can be family, thereby indicating that the user could be travelling for a vacation. The period of travel of the user can be in December, indicating that the user is on a vacation.

Further, an upper bounding level between the current location of the user and the future locations are compared. The upper bounding level can be defined as one of a state level or a country level of the future locations. For example, consider a user currently located in New York and desires to travel to Paris. Since New York and Paris are located in different countries, the upper bounding level is a country level.

At step 120, the future interests of the user are inferred.

Activities of the user at the future locations are analyzed to understand interest of the user at the future locations.

For example, the user may be involving in winter sports like skiing at a future location, which indicates that the user has travelled for vacation.

At step 125, user profiles are generated dynamically and statically.

A user profile can be defined as a description of purpose to travel to the future locations by the user. Examples of the user profiles include, but are not limited to, a vacationing user, a business user, a relocating user and a local user. The vacationing user is a user travelling to various holiday spots. A business user is a user on a business trip. The relocating user is a user shifting place of residence. Further, a local user is a user moving around in the city of residence.

The user profiles can be generated dynamically and statically. Further, the user profiles generated are time bound. The user profiles are generated in correspondence to the time at which the user reaches the future locations. In one embodiment, the user profiles can also be generated in correspondence to the time at which the user inputs the future locations. At each of the future locations, immediate future needs of the user are inferred. Accordingly, the user profile is generated.

The dynamic generation of the user profiles enables relevant advertisements to be displayed to the user. In one embodiment, appropriate web content can also be displayed to the user.

In one embodiment, the user profile is updated with each one of the future locations.

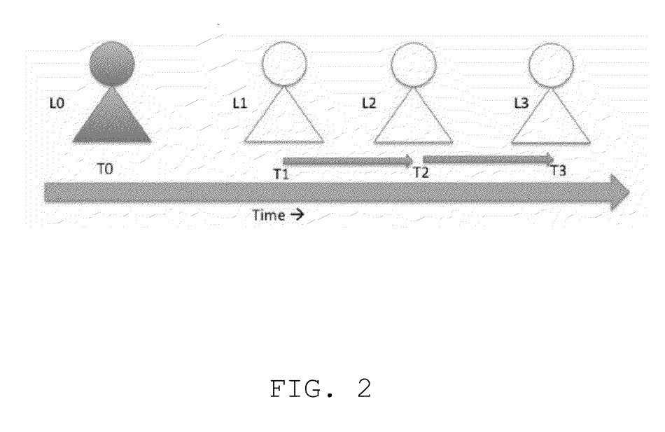

FIG. 2 is a schematic diagram illustrating a dynamic and time bound feature of generating user profiles, in accordance with one embodiment.

Consider a user at time “T0” at a current location “L0”. A user profile is generated in response to the user inputting the future locations to visit. As time progresses to “T1”, the user travels to a future location “L1”. At this point, the user profile can be updated based on the interest of the user at location “L1”. Similarly, the user travels during time period “T2” to future location “L2”. The user profile is updated only at end of the time period “T2”. Likewise, at time “T3”, the user travels to future location “L3”. Accordingly, the user profile is again updated only at the end of the time period “T3”.

In one embodiment, the user profiles are updated at the time when the user declares the future locations. For example, consider the user at time “T0” at the current location “L0”. A user profile is now generated based on the current location “L0”. The user then inputs future locations “L1”, “L2”, and “L3” at corresponding times “T1”, “T2” and “T3”. At this point of time, the user profile is updated in accordance with the future locations. Moreover, at any point of time, if there is a change to the future locations declared, the user profile is simultaneously updated.

The user profiles can also be generated statically.

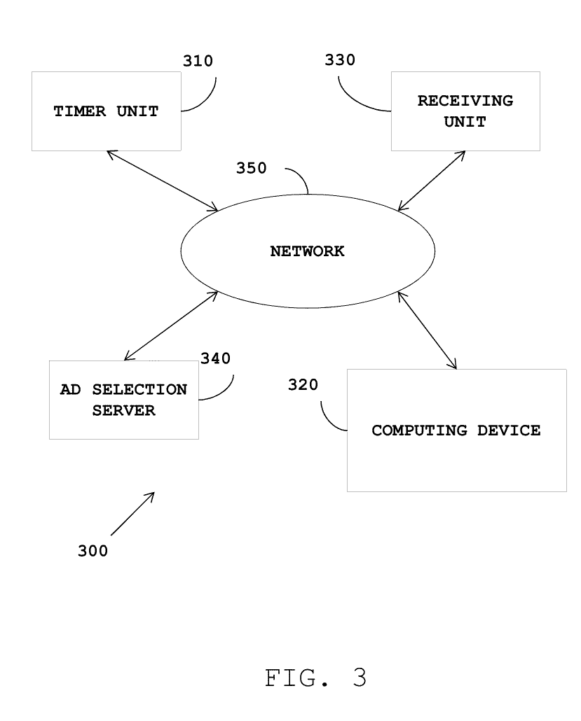

FIG. 3 is a block diagram illustrating a system for generating user profiles based on future locations of a user, in accordance with one embodiment. The system 300 includes a timer unit 310, a computing device 320, a receiving unit 330 and an ad selection server 340 in communication through a network 350.

The timer unit 310 tracks the time duration of the user at the future locations in response to receiving one of a user-inputted location, a GPS-based location, an IP address, and triangulation information.

The computing device 320 can be, for example, a PC, a stationary computing device, a laptop or notebook computer, a tablet computer, a smart phone or PDA, a smart appliance, or any other suitable processor-based device. In one embodiment, the computing device 320 is a location-aware device. The location-aware device is capable of signaling a corresponding physical location of the computing device 320. The computing device 320 is also capable to define an upper bounding level of the future locations, and to identify the attributes associated with the future locations. Additional embodiments of the computing device 320 are described in detail below.

The receiving unit 330 receives information corresponding to the current location of the user. Further, the information of the future locations of the user along with the time duration at each of the future locations is received. The information of the time duration is then sent to the timer unit 310. In one embodiment, the receiving unit 330 computes the time duration of the user at each of the future locations in response to travel dates received from the user. The time duration that is computed is then sent to the timer unit 310.

The ad selection server 340 selects appropriate advertisements and web pages based on the future locations and the time duration of the user at the future locations. The selected advertisements and the web pages are then targeted to the user in correspondence with the user arriving at each of the future locations.

In some embodiments, the timer unit 310 and the receiving unit 330 can be located in the computing device 320.

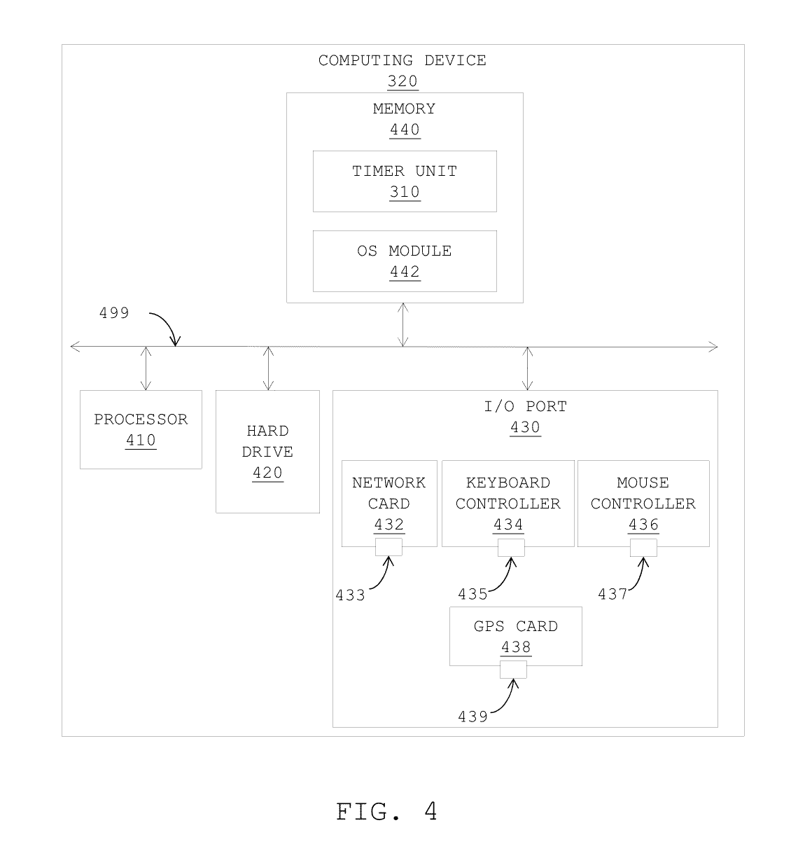

FIG. 4 is a block diagram illustrating a mobile computing device, for example computing device 320, in accordance with one embodiment.

The computing device 320 includes a processor 410, a hard drive 420, an I/O port 430, and a memory 440, coupled by a bus 499.

The bus 499 can be soldered to one or more motherboards. Examples of the processor 410 includes, but is not limited to, a general purpose processor, an application-specific integrated circuit (ASIC), an FPGA (Field Programmable Gate Array), a RISC (Reduced Instruction Set Controller) processor, or an integrated circuit. There can be a single core or multiple cores processor. In one embodiment, the processor 410 is specially suited for processing demands of location-aware reminders (for example, custom micro-code, and instruction fetching, pipelining or cache sizes). The processor 410 can be disposed on silicon or any other suitable material. In operation, the processor 410 can receive and execute instructions and data stored in the memory 440 or the hard drive 420. The hard drive 420 can be a platter-based storage device, a flash drive, an external drive, a persistent memory device, or other types of memory.

The hard drive 420 provides persistent (long term) storage for instructions and data. The I/O port 430 is an input/output panel including a network card 432 with an interface 433, along with a keyboard controller 434, a mouse controller 436, and a GPS card 438. The network card 432 can be, for example, a wired networking card (e.g., a USB card, or an IEEE 802.3 card), a wireless networking card (e.g., an IEEE 802.11 card, or a Bluetooth card), and a cellular networking card (e.g., a 3G card). The interface 433 is configured according to networking compatibility. For example, a wired networking card includes a physical port to plug in a cord, and a wireless networking card includes an antennae. The network card 432 provides access to a communication channel on a network. The keyboard controller 434 can be coupled to a physical port 435 (e.g., PS/2 or USB port) for connecting a keyboard. The keyboard can be a standard alphanumeric keyboard with 101 or 104 keys (including alphabetic, numerical and punctuation keys, a space bar, modifier keys, etc.), a laptop or notebook keyboard, a thumb-sized keyboard, a virtual keyboard, or the like. The mouse controller 436 can also be coupled to a physical port 437 (e.g., mouse or USB port). The GPS card 438 provides communication to GPS satellites operating in space to receive location data. An antenna 439 provides radio communications (or alternatively, a data port can receive location information from a peripheral device).

The memory 440 can be a RAM (Random Access Memory), a flash memory, a non-persistent memory device, or other devices capable of storing program instructions being executed. The memory 440 comprises an Operating System (OS) module 442 along with a timer unit 310. In other embodiments, the memory 440 comprises a calendar application that manages a plurality of appointments. The OS module 442 can be one of Microsoft Windows® family of operating systems (for example, Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The timer unit 310 can be implemented in the memory 440, as illustrated, have hardware assist, or be implemented completely in hardware.

In other embodiments, the timer unit 310 can be implemented to adjust other time-based events. For example, when a printer cartridge is nearing the end of its useful lifecycle, the timer unit 310 can calculate the time needed to order parts in addition to the time to failure. As a result, a reminder to replace the printer cartridge can be deployed taking into consideration ordering time. In still other embodiments, the timer unit 310 can be implemented in an automobile reminder system for oil changes or service, and adjust the associated reminders for an estimated wait for an appointment.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Many functionalities described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 802.11n). In one example, signals from the computer can be transferred, at least in part, wirelessly to components or other computers.

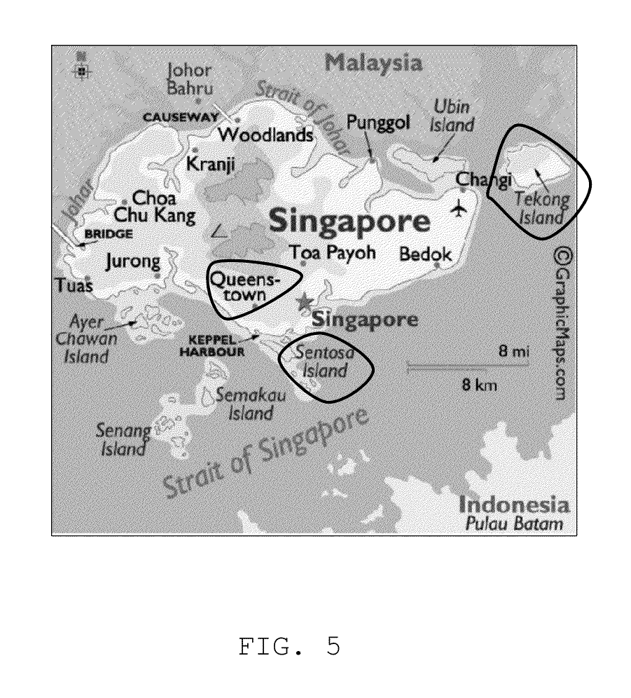

FIG. 5 is an exemplary representation of dynamically generating user profiles, in accordance with one embodiment.

Consider a user located currently in Delhi, India on tenth of May. The user declares future location as Sentosa Island, Singapore on fifteenth of May. Similarly, the user declares Tekong Island on seventeen of May and Queens Town on twentieth of May.

It can be observed that the current location of the user and the future locations are different. Moreover, all the future location of the user is within the same country, Singapore and further, a couple of days of travel apart. The upper bounding level is at the country level.

In correspondence with details observed, the user profile of the user can be identified as a business user or a vacationing user. The user cannot be a relocating user as the user is travelling to different places within Singapore. Similarly, the user cannot be a local user as the current location of the user and the future locations are different.

In addition, the user profile can be identified by considering a plurality of attributes. The attributes include the nature of the future locations, the relationship with the people the user is travelling, and the period of travel. For example, Sentosa Island, Tekong Island and Queens Town are all tourist destinations. Further, the period of travel falls within a vacation period in India (Fifteenth of May) and therefore the user profile can be further identified as a vacationing user and not a business user. In another example, if the future locations are of business destinations and the period of travel is for a couple of months, then the user profile can be identified as a business user.

At this point, the user profile has been identified as a vacationing user. As the user reaches a first future location, Sentosa Island, advertisements and web pages are targeted to the user when browsing the Internet. The advertisements and the web pages are relevant to needs of the user at Sentosa Island. Similarly, the user profile is again updated when the user reaches a next future location, Tekong Island. Another set of advertisements and web pages are displayed to the user according to the needs of the user at Tekong Island. Yet again, the user profile is updated at Queens Town and appropriate advertisements and web pages are displayed to the user.

In one embodiment, the user profile is updated at the time when the user declares the future locations (Sentosa Island, Tekong Island and Queens Town).

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for generating user profiles based on future locations of a user, the computer-implemented method comprising:
receiving one or more future locations along with time duration of a user at each of the one or more future locations;
identifying a plurality of attributes associated with the one or more future locations;
inferring the future interests of the user; and
generating user profiles in accordance with the time duration of the user at each of the one or more future locations, wherein the generating is performed dynamically and statically.

2. The computer-implemented method of claim 1 further comprising:
receiving a current location of the user; and
comparing an upper bounding level of the current location and the one or more future locations.

3. The computer-implemented method of claim 2, wherein the upper bounding level is a state level or a country level of the one or more future locations.

4. The computer-implemented method of claim 1 further comprising:
updating the user profile in accordance with the user travelling to each of the one or more future locations.

5. The computer-implemented method of claim 4, wherein the updating is performed in correspondence to the user declaring the one or more future locations.

6. The computer-implemented method of claim 1 further comprising,
analyzing one or more user activities at each of the one or more future locations.

7. The computer-implemented method of claim 1, wherein the plurality of attributes includes at least one of the nature of the one or more future locations, the relationship between the one or more future locations, the relationship between the user and the people with whom the user travels, and the period of travel of the user.

8. The computer-implemented method of claim 1, wherein the user profile comprises categorizing the user as at least one of a vacationing user, a business user, a relocating user and a local user.

9. The computer-implemented method of claim 1 further comprising,
displaying relevant advertisements to the user based on the generated user profile; and
displaying appropriate web content to the user.

10. A computer program product stored on a non-transitory computer-readable medium that when executed by a processor, performs a method for generating user profiles based on future locations of a user, comprising:
receiving one or more future locations along with time duration of a user at each of the one or more future locations;
identifying a plurality of attributes associated with the one or more future locations;
inferring the future interests of the user; and
generating user profiles in accordance with the time duration of the user at each of the one or more future locations, wherein the generating is performed dynamically and statically.

11. The computer program product of claim 10 further comprising:
receiving a current location of the user; and
comparing an upper bounding level of the current location and the one or more future locations.

12. The computer program product of claim 11, wherein the upper bounding level is a state level or a country level of the one or more future locations.

13. The computer program product of claim 10 further comprising:
updating the user profile in accordance with the user travelling to each of the one or more future locations.

14. The computer program product of claim 13, wherein the updating is performed in correspondence to the user declaring the one or more future locations.

15. The computer program product of claim 10 further comprising,
analyzing one or more user activities at each of the one or more future locations.

16. The computer program product of claim 10, wherein the plurality of attributes includes at least one of the nature of the one or more future locations, the relationship between the one or more future locations, the relationship between the user and the people with whom the user travels, and the period of travel of the user.

17. The computer program product of claim 10, wherein the user profile comprises categorizing the user as at least one of a vacationing user, a business user, a relocating user and a local user.

18. The computer program product of claim 10 further comprising,
displaying relevant advertisements to the user based on the generated user profile; and
displaying appropriate web content to the user.

19. A system for generating user profiles based on future locations of a user, the system comprising:
a receiving unit to receive one or more future locations having time duration of a user at each of the one or more future locations, and to receive a current location of the user;
a computing device to define an upper bounding level of the one or more future locations and to identify a plurality of attributes associated with the one or more future locations;
a timer unit in communication with the computing device, to track the users duration at the one or more future locations, and
an ad selection server in communication with the computing device.

20. The system of claim 19, wherein the computing device generates the user profile dynamically and statically in accordance with the user travelling to each of the one or more future locations.

21. The system of claim 19, wherein the computing device categorizes the user as at least one of a vacationing user, a business user, a relocating user and a local user.

22. The system of claim 19, wherein the ad selection server performs at least one of displaying relevant advertisements to the user based on the generated user profile and displaying appropriate web content to the user.
